(19) United States
(12) Patent Application Publication
(10) Pub. No.: US 2009/0064149 A1
(43) Pub. Date: Mar. 5, 2009

(54) Latency coverage and adoption to multiprocessor test generator template creation

(75) Inventors: Padmaraj Singh, Dresden (DE); Todd Foster, Austin, TX (US); Dennis Lastor, Austin, TX (US)

Correspondence Address: MEYERTONS, HOOD, KIVLIN, KOWERT & GOETZEL (AMD), P.O. BOX 398, AUSTIN, TX, 78767-0398, US

(73) Assignee: Advanced Micro Devices, Inc.

(21) Appl. No.: 12/011,515

(22) Filed: Jan. 28, 2008

(30) Foreign Application Priority Data
Aug. 31, 2007 (DE) 10 2007 041 212.8

(51) Int. Cl. G06F 9/46

(52) U.S. Cl. 718/101

(57) ABSTRACT

A multi-core multi-node processor system has a plurality of multiprocessor nodes, each including a plurality of microprocessor cores. The plurality of microprocessor nodes and cores are connected and form a transactional communication network. The multi-core multi-node processor system has further one or more buffer units collecting transaction data relating to transactions sent from one core to another core. An agent is included which calculates latency data from the collected transaction data, processes the calculated latency data to gather transaction latency coverage data, and creates random test generator templates from the gathered transaction latency coverage data. The transaction latency coverage data indicates at least the latencies of the transactions detected during collection of the transaction data having a pre-determined latency, and includes, for example, four components for transaction type latency, transaction sequence latency, transaction overlap latency, and packet distance latency. Thus, random test generator templates may be created using latency coverage.

### BACKGROUND OF THE INVENTION

1. Field of the Invention

The invention generally relates to multiprocessor systems, and in particular to measuring and capturing transaction coverage data based on transaction latencies in a multiprocessor system.

2. Description of the Related Art

Multiprocessor systems are computing environments that use two or more central processing units (CPUs) within a single platform. Multiprocessing also refers to the ability of a computing system to support more than one processor and to allocate tasks between them. In general, multiprocessing systems may be built using multiple cores on one die, multiple chips in one package, multiple packages in one system unit, or the like.

Such multiprocessor systems may become quite complex and therefore require powerful tools to validate the correctness and robustness of the overall operation. Such validation is helpful both in the design phase as well as at a later stage in simulation or real operation processes.

When validation is performed, coverage data is gathered using a test program. Further, since simulation may be the main part for validating systems of large and complex designs, stimuli generation for simulation plays a central role. The generated stimuli are designed to trigger architecture and micro-architecture events. The stimuli may take the form of test programs, while a possible input for a test program generator could be the specification of a test template consisting of a set of tests that exercise the multiprocessing system.

The validation of multiprocessing systems and generation of test templates is a difficult task. As compared to simulation, an actual system, in a short period of time, produces a significantly larger amount of validation data. It is noted that, historically, typical transaction coverage included exercising a relevant subset of transaction types with a few permutations and combinations of transaction sequences.

### SUMMARY OF THE INVENTION

A multiprocessor technique is provided which may facilitate measuring and/or capturing of coverage data based on transaction latency data. Embodiments may allow for generating random multiprocessor program generator templates by evaluating transaction types, transaction sequences, overlapping transaction types and/or packet distances of packets in a transaction.

According to an embodiment, there is provided a method in a multi-core processor system. The method comprises collecting transaction data that relates to transactions in the multi-core processor system and calculating latency data from the collected transaction data. The method further comprises processing the calculated latency data to gather transaction latency coverage data and creating random test generator templates from the gathered transaction latency coverage data. The transaction latency coverage data indicates at least the latencies of the transactions detected during collection of the transaction data having a pre-determined latency.

In another embodiment, a multi-core multi-node processor system comprises a plurality of multiprocessor nodes each having a plurality of microprocessor cores. The plurality of microprocessor nodes and cores are connected to form a transactional network, such as a transactional point-to-point communication network. The multi-core multi-node processor system further comprises one or more buffer units which are configured to collect transaction data relating to transactions sent from one core to another core. The multi-core multi-node processor system also comprises an agent configured to calculate latency data from the collected transaction data, to process the calculated latency data to gather transaction latency coverage data, and to create random test generator templates from the gathered transaction latency coverage data. The transaction latency coverage data indicates at least the latencies of the transactions detected during collection of the transaction data having a pre-determined latency.

In a further embodiment, a test program template generator comprises a collection unit configured to collect transaction data that relates to transactions in a multi-core processor system and a latency calculator configured to calculate latency data from the collected transaction data. The test program template generator further comprises a data processing unit configured to process the calculated latency data to gather transaction latency coverage data and a template creator configured to create random test generator templates from the gathered transaction latency coverage data. The transaction latency coverage data indicates at least the latencies of the transactions detected during collection of the transaction data having a pre-determined latency.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 is a block diagram illustrating a multi-core multi-node microprocessor system according to an embodiment;

FIG. 2 illustrates the timing of packets in transactions according to an embodiment;

FIG. 3 illustrates contents of trace capture buffers in a multi-node microprocessor system according to another embodiment;

FIG. 4A illustrates various coverage ranges during different quiescent mode stages in relation to the probability of transaction latency for a certain transaction type according to another embodiment;

FIG. 4B illustrates subsequent coverage ranges for quiescent mode stages according to an embodiment;

FIG. 4C depicts example transaction type latency ranges for different quiescent mode stages;

FIG. 4D provides coverage ranges for different transaction types according to an embodiment;

FIG. 4E illustrates overlapping transaction types according to a further embodiment;

FIG. 4F depicts an example transaction overlap latency range according to another embodiment;

FIG. 5 provides several shapes of Gaussian distributed latencies for certain transaction types in accordance with embodiments;

FIG. 6 is a flowchart illustrating steps to be performed to generate random multi-processor program templates according to an embodiment;

FIG. 7 is a flowchart illustrating the process performed when running an MP test program in more detail in accordance with a further embodiment;

FIG. 8 is a flowchart illustrating the steps of processing data to gather latency coverage data according to another embodiment;

FIG. 9 is a flowchart illustrating how transaction latency coverage data may be gathered according to an embodiment;

FIG. 10 is a block diagram illustrating the process of data gathering from workloads and system parameters according to an embodiment;

FIG. 11 is a block diagram summarizing the use of RMPPT for 24×7 MP system regressions in accordance with a further embodiment and

FIG. 12 is a block diagram depicting an exemplary system in which the present invention may be implemented.

### DETAILED DESCRIPTION OF THE INVENTION

The illustrative embodiments of the present invention will be described with reference to the figure drawings wherein like elements and structures are indicated by like reference numbers.

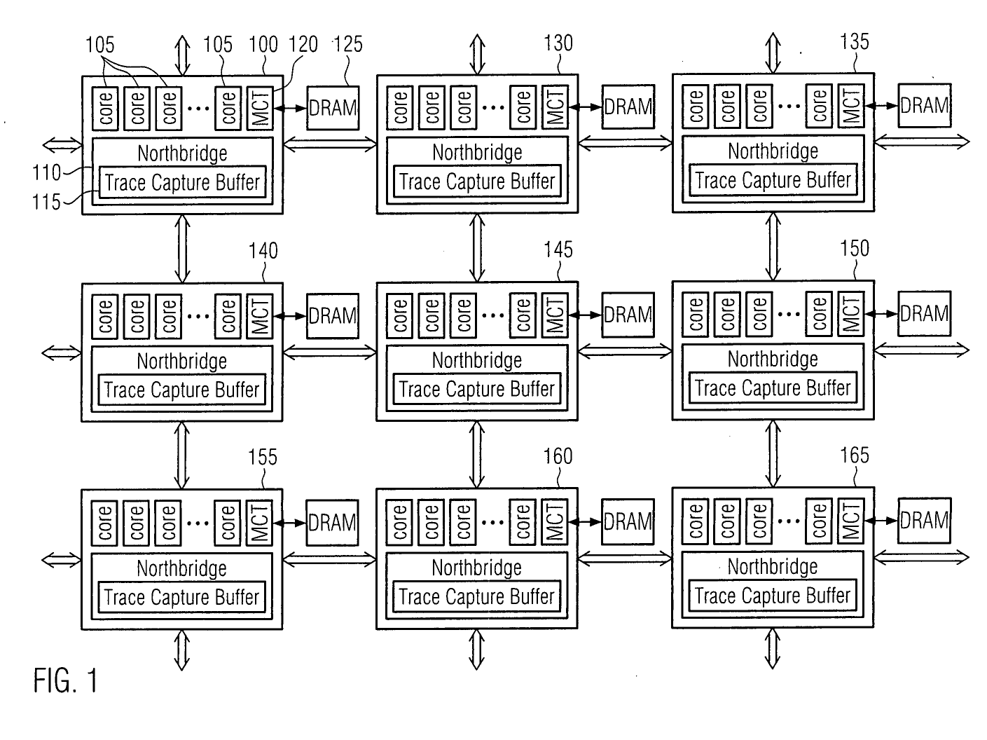

Referring firstly to FIG. 1, a multi-core multi-node microprocessor system is shown according to an embodiment. The system includes a number of nodes 100, 130, 135, 140, 145, 150, 155, 160, 165 which are coupled to each other to form a point-to-point communication network. In each of the nodes, there may be a plurality of processor cores 105 which are part of the network.

The multi-core multi-node communication network shown in FIG. 1 may be a transactional network in the sense that transactions may be sent from one core to another core within a node, or from one node to another node. Thus, there may be intra-node as well as inter-node traffic in the multi-core multi-node microprocessor system of the embodiment shown in FIG. 1.

In the embodiment, the multi-core microprocessors forming the nodes 100, 130-165 combine two or more independent processors 105 into a single package, or into a single integrated circuit. The multi-core microprocessors may exhibit some form of thread-level parallelism without including multiple microprocessors in separate physical packages. Thus, the multi-core microprocessors themselves may allow for some kind of chip-level multiprocessing.

A plurality of nodes may be placed on a single motherboard or, in another embodiment, may be at least in part packaged together. In another embodiment, some or all of the nodes may even be loosely coupled or disaggregated to some extent.

As shown in FIG. 1, each node 100, 130-165 of the transactional point-to-point communication network has a northbridge 110. A northbridge, or memory controller hub (MCH), is a chip in the core logic chipset that may handle communications between the processor's cores 105 and memory. In the embodiment of FIG. 1, the northbridge 110 in each node 100, 130-165 is connected to the cores 105 of the respective node, and to a memory controller (MCT) 120. The northbridge 110 is also used to handle the inter-node traffic. It is noted that other embodiments may make use of bridge elements other than northbridges.

As mentioned above, the nodes and cores form a transactional point-to-point communication network. In an embodiment, the multi-core multi-node microprocessor system of FIG. 1 may be configured to use HyperTransport transactions, but other embodiments may exist that make use of other transactions. In general, a transaction may be understood to be a single activity within a computer system that may be signaled by means of a message that requires a response or does not require a response, dependent on the type of transaction.

As will be described in more detail below, transactions may be built from multiple packets that are sent to or received from the respective nodes and cores at different points of time. In the embodiment, transactions are used to perform atomic updates for critical tasks in the multiprocessor environment.

In an embodiment, intra-node traffic and inter-node traffic may be captured to be analyzed in a post-silicon microprocessor validation process. Intra-node traffic, i.e. inter-core traffic, may be captured in the embodiment through a trace capture buffer (TCB) 115 present in each node 100, 130-165. Inter-node traffic may be captured through a logical analyzer (not shown). It is noted that the trace capture buffers 115 may be used in other embodiments to capture both intra-node as well as inter-node traffic.

As apparent from FIG. 1, the trace capture buffers 115 of the present embodiment are located within the northbridges 110 or other bridge elements used in the multi-core microprocessors 100, 135-165 for handling the transactional traffic. According to other embodiments, the trace capture buffers 115 may be located within each node but external to the northbridge 110.

In an embodiment which will be described in the following, the trace capture buffers 115 are programmed to capture all inter-core and inter-node packets flowing through the system. The trace capture buffers 115 will further time stamp each packet at the time of capturing the packet. Thus, the time stamp may indicate a point of time at which the respective packet has been captured and stored in the buffer. This point of time may be equal or similar to the point of time at which the packet was sent or received by the respective node or core. In other embodiments, there may be a small time difference between sending and receiving the packets, and capturing them in the buffer.

The time stamp may be based in an embodiment on a globally usable and synchronized clock (not shown). By using a global clock, it is ensured that the time stamps of all captured packets in all trace capture buffers 115 may be validly compared.

In the present embodiment, the trace capture buffers 115 in each node 100, 130-165 are configured to capture any traffic passing through the respective northbridge 110. In this embodiment, a northbridge 110 acts as coherency point for the respective node 100, 130-165. That is, all inter-core traffic, any access to the memory controller 120, and any access to remaining nodes 100, 130-165 and peripherals of the system (not shown) pass through the northbridge. It is to be noted that the communication network may transport coherent and non-coherent traffic.

The present embodiment chooses the size of the trace capture buffers 115 to be large enough to be non-intrusive, even for large multiprocessor programs. However, it may nevertheless happen that a trace capture buffer 115 is completely filled. The trace capture buffer may then drain (or store) its contents in the memory 125, which may be a DRAM (Dynamic Random Access Memory). This process may be controlled by the memory controller 120.

In an embodiment, the trace capture buffer 115 will stall the northbridge while it empties its contents into the DRAM. The act of stalling the northbridge 110 may make the trace capture buffer 115 intrusive but when choosing the size of the trace capture buffer 115 to be sufficiently high there will be almost no need to stall the northbridge 110 anymore.

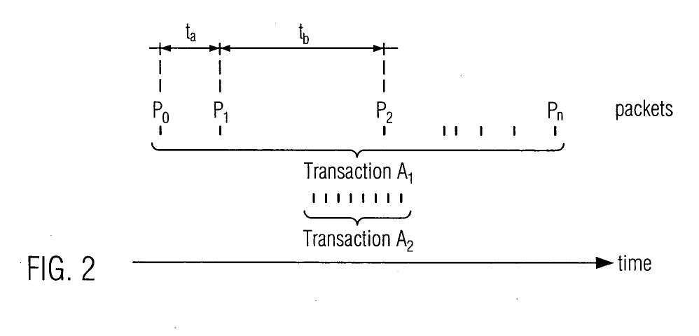

As already mentioned above, each transaction may contain multiple packets. Referring to FIG. 2, the number and type of packets per transaction may vary from transaction to transaction. Referring to FIG. 2, two transactions, A₁ and A₂, are shown which are of the same type. As can be seen from the figure, transactions of the same type may require vastly different time periods to complete. These transactions may have packets occurring in the same sequence, but the packet time stamps relevant to each other may be completely random. It is noted that this may be due to a communication protocol which does not restrict the minimum time required to complete a transaction, and which does not restrict the elapsed time between packets for a given transaction.

It is further noted that packets from different transactions may be randomly interspersed between other transactions. In this case, the northbridge 110 of the respective node 100, 130-165 stitches the packets together based on the transaction ID to form or complete the transaction. Each transaction may have an initiating core and may contain packets destined for and arriving from multiple nodes/cores.

For each packet in a given transaction type, two properties are defined, i.e. the distance (in time) from the preceding packet (tₐ) as well as the distance from a succeeding packet (t_{b}). As discussed in greater detail below, these properties may be derived for each packet of observed transactions. In an exemplary implementation, the derived packet properties, i.e. the timely packet distances, may be used to further evaluate properties of transactions. For instance, the total transmission time of a transaction may be derived from its packet properties. In addition, packet latencies, as well as transaction latencies may be calculated based on the packet distances.

In a further embodiment, the total transaction time for two transactions of the same type might be equal. However, in this further embodiment, the time distance between two subsequent packets might vary from transaction to transaction. For instance, the packet P₁ has a time stamp indicating the time of the P₀ time stamp plus the distance (in time) tₐ. This time difference tₐ between the first two packets might be of a different value for transaction A₁ than the corresponding time difference between the first two packets of transaction A₂, although both transactions may be of the same type. The same effect may be seen for the time difference of the subsequent packets P₁ and P₂, i.e. t_{b}. However, in another embodiment, the sum of the values tₐ and t_{b} for transaction A₁ may be equal to the value of tₐ plus t_{b} in the transaction A₂, although tₐ and t_{b} are different for each transaction.

In another embodiment, the two packet properties (or time differences tₐ and t_{b}) are each represented by a normal distribution, such as a distribution function in accordance with the Gaussian function. In an exemplary implementation, the normal distribution represents the varying time difference tₐ for the first two packets of a plurality of transactions. The transactions of this plurality may be of the same type to allow an accurate evaluation of the time difference distribution. However, in another implementation, the transactions may be of different types. It is further to be noted that other probability distribution functions can be used in further embodiments. For instance, a distribution function may be chosen that is symmetric and has its maximum at the value of the mean distance. For instance, a function can be chosen to have a triangular curve linearly increasing with growing distance up the mean distance, and decreasing with further growing distance. It is to be noted that embodiments may exist even having asymmetric functions.

Referring back to the embodiment applying a normal distribution, the mean distance from the preceding packet is referred as μₐ. Further, the mean distance from the succeeding packet is referred as μ_{b}. Correspondingly, σₐ and σ_{b} are referred to as the variations of the distance from the preceding and the succeeding packets, respectively. Because transactions have variable latencies, the distances are computed as a percentage of the transaction latency. In a further embodiment, the distances may be computed as a percentage of the total transaction time. However, for both embodiments, this makes the distance values independent of the total transaction time, and allows packet distances tₐ and t_{b} to be compared from transaction to transaction.

In one embodiment, transactions generally have variable latencies. The transaction latency may correspond or be set equal to the total transaction time. The total transaction time may be the sum of all packet distances of the transaction. In another embodiment however, the transaction latency may also be calculated by subtracting a minimum transaction time from the actual measured transaction time. The minimum transaction time may be measured in previous evaluations, but may also be calculated from hardware parameters, such as the data communication rate, e.g, of the northbridge. In a further implementation, the transaction latency is derived from a mean latency of previously observed transactions, such as during previous experiments or evaluating former systems. Again, the transaction latencies may be calculated for each type of transaction for better comparison results. However, the latencies may also be examined for all transactions of a certain time period, test program module, processor core and so on.

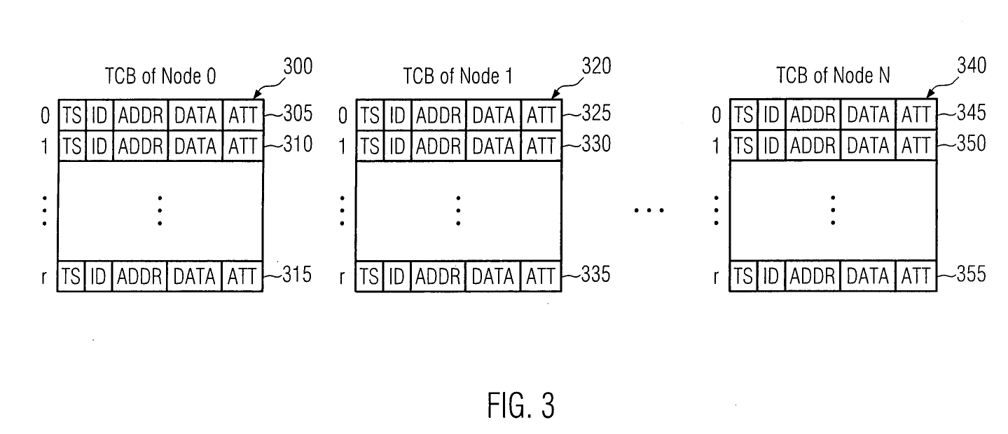

As described above, the trace capture buffers 115 of the microprocessor nodes 100, 130-165 may capture the transactions to collect respective packet data. This data may be captured in the trace capture buffers 115 in the form shown in FIG. 3. As can be seen from this figure, the trace capture buffers 115 in each node 100, 130-165 may store the packet information in tables 300, 320, 340. Each row 305, 310, 315, 325, 330, 335, 345, 350, 355 in each node 100, 130-165 includes packet information of a single packet. Each row may have a field TS storing a time stamp, a field ID storing the transaction ID, source ID and destination ID, a field ADDR storing a target address, a field DATA storing data, which might be for reading, modifying and/or writing, and a field ATTR storing attributes of the packet. Although not shown in FIG. 3, there may optionally be a field in each row storing the transaction type.

It is shown in FIG. 3 that there are N nodes, each having r rows. It is, however, to be noted that the number of rows may differ from node to node.

As will be described in more detail below, the embodiments may make use of the buffered transaction packet information to determine a transaction type, transaction latency, packet-to-packet distances, etc.

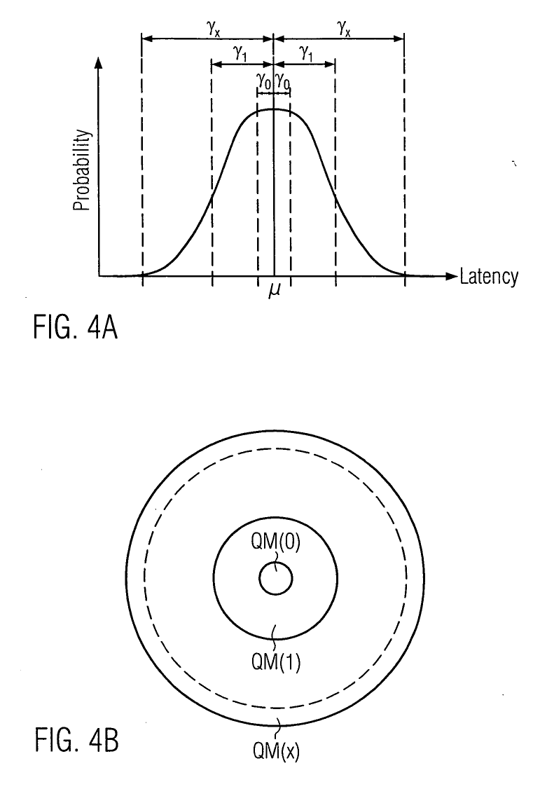

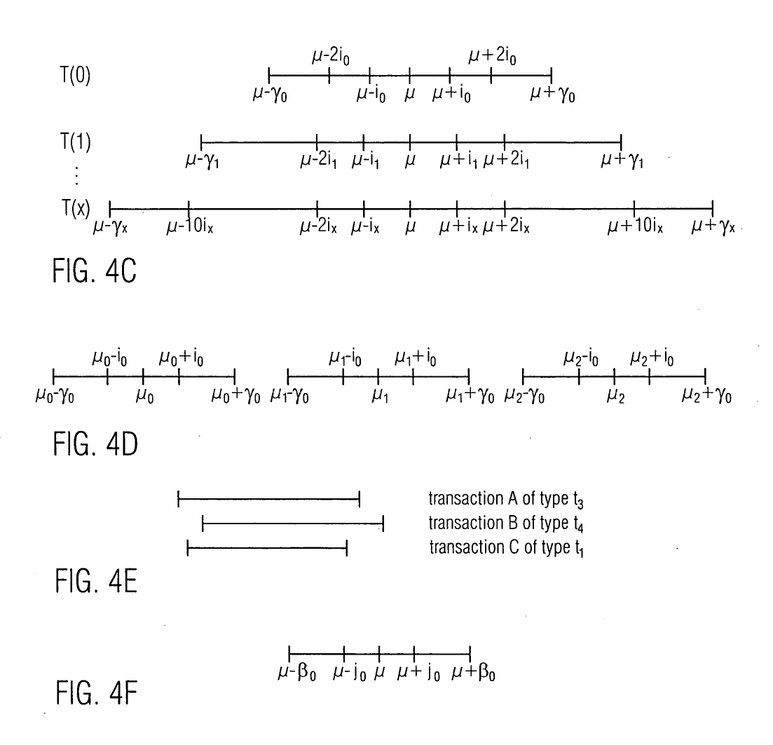

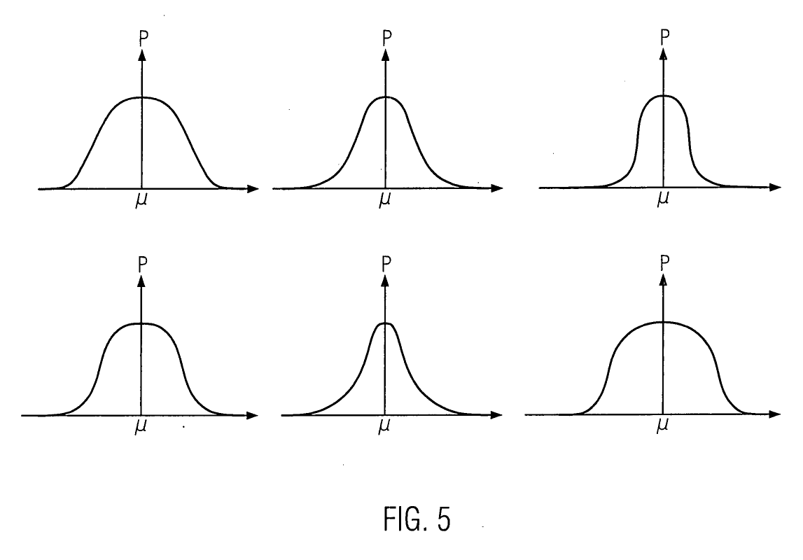

Referring now to FIGS. 4A and 4B, latency coverage ranges are depicted. In particular, FIG. 4A shows a possible latency profile of a certain transaction type represented by a normal distribution. In other words, the curve depicted in FIG. 4A reflects the probability or frequency that a certain latency for the particular transaction type occurs. In an exemplary embodiment, the latency distribution as depicted in FIG. 4A represents the latency of a certain transaction type observed on a multi-core microprocessor node of FIG. 1 during execution of a test program on the multi-core multi-node processor system.

With respect to FIG. 5, exemplary profiles are depicted for different transaction types. It is to be noted that for different transaction types the probability is approximately one (P≈1; e.g. P=0.95) when the x=μ (mean latency). However, the maximum variance may vary from transaction type to transaction type, resulting in diverse shapes of probability distribution curves. Further, it is to be noted that in different implementations the maximum probability may be considerably less than one. The probability function may also not have its maximum at x=μ, for example, the maximum could arise at x=μ+/−σ, or the like. In another embodiment, two diverse transaction types may have the same probability parameters resulting in identical distribution curves. It is again noted that the distribution functions of the transaction types in various embodiments do not need to represent a normal distribution or Gaussian distribution, but other possible probability distribution functions can be used.

Referring back to FIGS. 4A and 4B, the depicted embodiment collects transaction latency based coverage in a subsequent manner using subsequent ranges of latency around the mean latency, i.e. μ±γ. Different stages may be used when collecting coverage data. These stages begin with a relative small range around the mean latency, i.e. μ±γ₀. Subsequent stages use a wider range of latencies defined by μ±γ₁ and so on, until a final stage covers the range defined by γₓ.

This allows coverage with significantly enhanced depth and breadth to be collected than has been covered historically. As a consequence of covering a wide range of transaction sequences and latencies, many random test generator templates may be created. In an exemplary implementation, a random test generator template may be a set of tests that exercise the cache or memory of the processor. The obtained random test generator templates may provide a basis for the input to a test program generator. For instance, these templates may be used as the basis for 24×7 regressions on multiprocessor systems.

In another exemplary implementation, coverage metrics may be employed that measure verification activity with respect to items in a high-level functional or micro-architecture specification. In particular, specifications may deal with the input/output behaviors of the design, the types of transactions that can be processed and the data transforms that must occur. A possible coverage metric determines how many of certain behaviors that must be exercised have been verified. One example may be a transactional coverage which measures the number and types of transactions exercised in simulations. Further, in another embodiment, transactional coverage may measure number and types of transactions exercised in a real environment. It is to be noted that other coverage data may be measured, such as transaction times, packet-related data of the transactions or transaction latency.

Referring now to FIG. 4B, different stages are depicted which gradually increase in rigor and which are subdivided from 0 through x. In particular, the term “quiescent mode” is used herein, where a quiescent mode (QM) system is running under typical conditions. Systems are designed to perform optimally under typical conditions. On the other hand, workload simulations generate data on transaction traffic for typical and extreme modes. The described embodiment, however, uses the term quiescent rather than “typical” because the system is designed to handle normal load. Thus, in this embodiment, i.e. the quiescent mode, it is not required to perform abnormal or extreme operations. In another embodiment, however, extreme modes may also be evaluated.

Moreover, random test generator templates, such as random multiprocessor program generator templates (RMPPT), are created based on a very high transaction latency coverage during various QM stages. As depicted in FIGS. 4A and 4B, during a first QM stage, QM(0), the system may run typical applications with minimal disturbances. The transaction latency coverage points are much easier to hit during this first stage QM(0). As can be further seen, coverage targets are increased during subsequent QM stages, and QM(1) will target coverage points of QM(0) and beyond. Similarly, the coverage target for QM(2) equals QM(0) plus QM(1) plus coverage defined for stage 2. Finally, QM(x) covers all previous QM coverage and all extreme cases not covered by earlier QM stages. On reaching closer to the QM(x) stage, variations in transaction traffic and latencies increase significantly (see FIG. 4A). Thus, special effort is required to create RMPPTs to create extreme permutations of transaction sequences and transaction latencies.

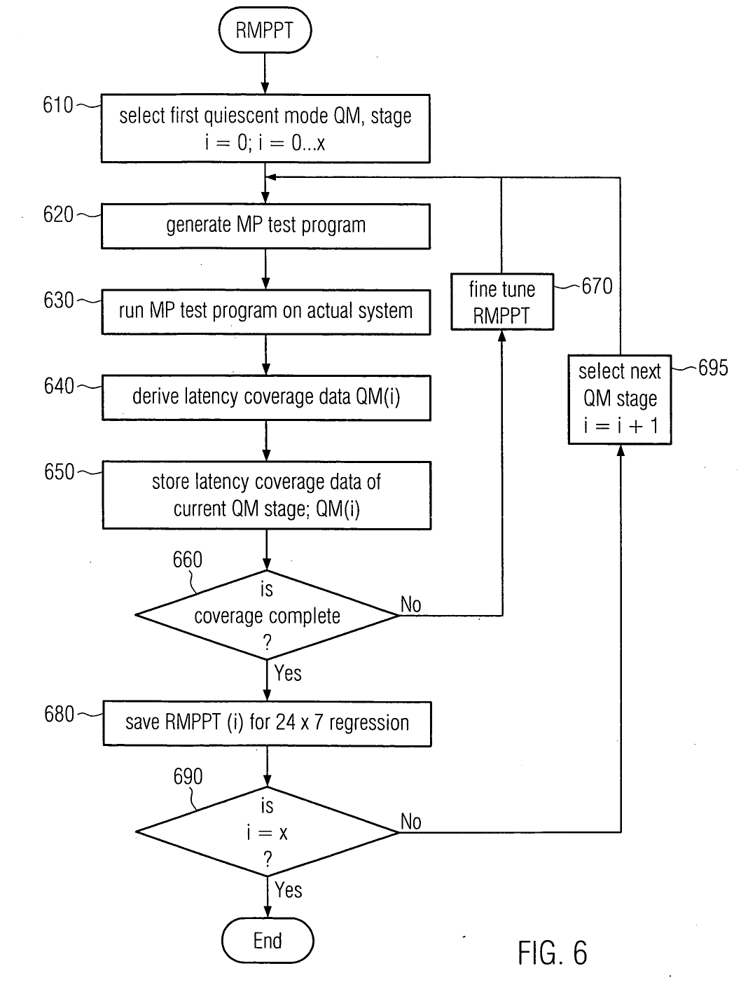

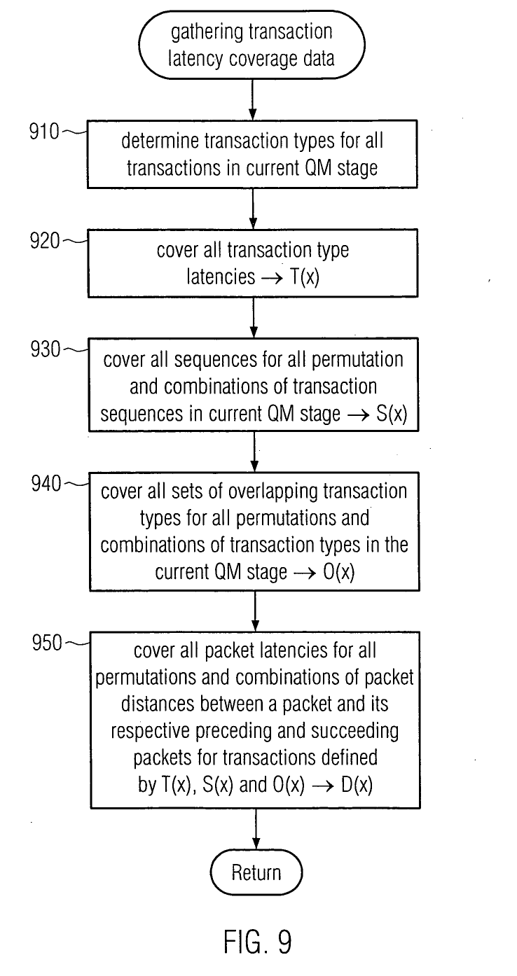

The above described overall process is summarized in FIG. 6 in accordance with an embodiment. The process begins with the selection of a first quiescent mode stage at step 610. As mentioned above, a multiprocessor, MP, test program is generated in step 620. In an embodiment, the multiprocessor test program may be generated on the basis of a test template which is used for every multiprocessor system when beginning the process at the first QM stage. It is to be noted that in a further embodiment, the MP test program may be generated using a template especially created for the current process or a certain multiprocessor system. Returning to FIG. 6, the MP test program is run on the actual multiprocessor system as indicated in step 630. From this program run, in step 640, latency coverage data is derived for the current QM stage, i.e. first QM(i); where i=0, which is discussed in more detail below in conjunction with FIG. 9. In an embodiment, the derived latency coverage data may be stored in a buffer 115 or DRAM 125. However, the latency coverage data can be stored in any type of accessible data storage or memory, or cannot be stored at all but further processed in an external system. However, in this embodiment, the latency coverage data is stored as indicated by step 650. In step 660, it is then determined whether the coverage is complete for the current OM stage. For example, it may be determined whether a certain percentage of a possible amount of coverage data has been derived. In another implementation it may be determined whether the coverage is complete by evaluating possible coverage points which need to be hit when the MP test program runs on the system, and whether all or a certain percentage of these coverage points are already hit.

If the coverage is not complete, the RMPPT is fine-tuned as indicated by step 670. The template is iteratively fine tuned until coverage is complete. Thus, the method continues with repeating the steps 620 through 670, until it is determined that the coverage is complete. However, in a further implementation, the process does not determine whether the coverage is complete to provide a more time efficient process saving fine-tuning cycles.

Referring back to the depicted embodiment, if the coverage is complete, the embodiment may save, step 680, the template of the current QM stage (RMPPT(i)) for future use. The process then continues to step 690, where it is determined whether the last QM stage has been processed. For example, it may be determined whether the maximum value of i, i.e. the i^{th} QM stage, has been reached. If there is at least another QM stage to evaluate, i.e. i<x, then the next QM stage is selected which corresponds to add 1 to i; (i=i+1), step 695. The process then repeats the steps of 620 to 680 until the last QM stage has been processed.

After processing the last QM stage and determining that i=x in step 690, the process depicted in FIG. 6 ends. In an exemplary embodiment, the templates RMPPTs for all QM stages are saved or copied to a different storage for further evaluation. In a possible implementation of the invention, one saved RMPPT comprises the stored latency coverage data for all QM stages, i.e. QM(x). However, in another implementation, one RMPPT is saved for each QM stage, i.e. RMPPT(i) corresponding to each QM(i).

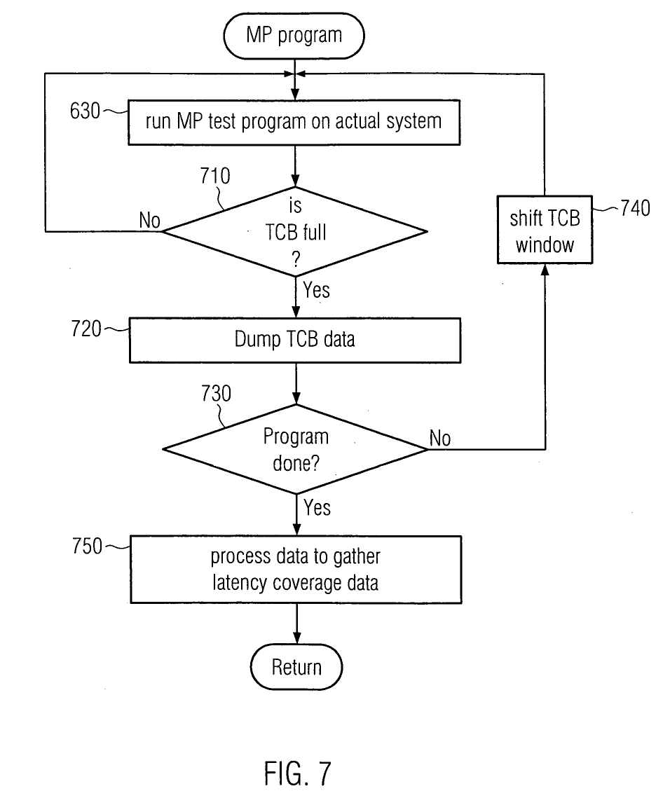

A specific example can be described in greater detail by FIG. 7, where the MP test program and the derivation of latency coverage data is further outlined. As mentioned above, transaction latency data is constructed from time-stamped data captured in a TCB 115. Once the TCB is filled, it becomes intrusive. Therefore, a step 710 determines whether the TCB is full. If not, the process illustrated in FIG. 7 follows the “no” branch, which results in continuing with the MP test program run. However, if the TCB is full, the TCB data are dumped. In an embodiment, the data stored in the TCB are deposited in a different memory, such as DRAM 125. In a further embodiment, the dumped data may be copied or transferred to a memory of a monitoring or observing computer system.

Referring to the described embodiment depicted in FIG. 7, once the TCB is filled, data is collected by shifting enabling of TCB across the MP test program. Thus, the intrusion due to coverage data collection is eliminated. Further, step 730 determines whether the MP test program is done. If not, the TCB window is shifted as indicated in step 740 and outlined above. For instance, in an embodiment, the address range of the current TCB is shifted, so that a new TCB window is used for the further MP test program run. It is to be noted that other addressing or memory techniques may be used for or instead of shifting the TCB window.

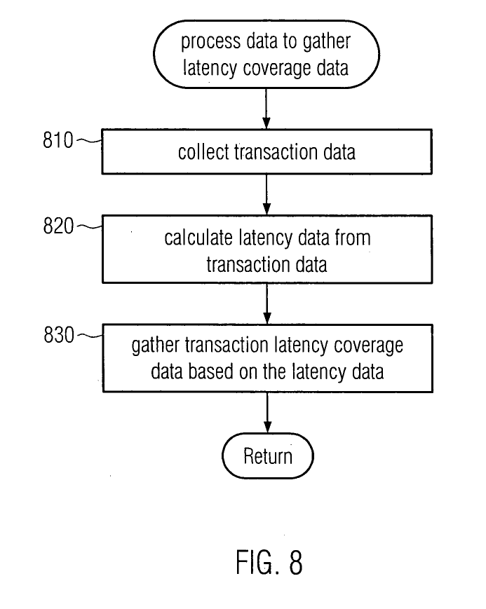

If the program is done, the data is processed to gather latency coverage data as indicated in step 750, which will be discussed in more detail with reference to FIG. 8.

FIG. 8 schematically shows the process of gathering latency coverage data. In a step 810, the transaction data is collected. In detail, the transaction data may be collected by identifying transactions from the data stored in the TCB, where transactions are identified by transaction IDs, as well as packet data of the corresponding transactions. Thus, in an embodiment, the transaction data may include information about the number of transactions, transaction types, number of packets per transaction, packet properties, etc.

As indicated in step 820, latency data is calculated from the collected transaction data. In particular, the calculated latency data may be a latency value for each determined transaction of all transactions currently evaluated. As mentioned above, the latency data may be calculated from the time stamp data of each packet derived from the TCB. Moreover, the latency data may be specified for each transaction type of the collected transactions. Further, transaction latency coverage data is gathered based on the latency data as indicated at step 830 and further discussed below. Generally, the transaction latency coverage data includes data indicating the latencies of the transactions detected or evaluated during collection of the transactions. However, the transaction latency coverage data may include other data relating to the transactions and corresponding latencies. In an embodiment, only transactions and corresponding data is covered where the latencies of the transactions fall into a pre-determined range.

In detail, FIG. 9 illustrates a detailed process of gathering transaction latency coverage data during subsequent quiescent mode, QM, stages. In general, four components for the QM stages are defined. These four components for QM(x) are a transaction type latency coverage, transaction sequence latency coverage, transaction overlap latency coverage and packet distance latency coverage, herein referred to as T(x), S(x), O(x) and D(x), respectively. The value x refers to different QM stages from a first stage (x=0) to a last stage (x). Therefore, the total latency coverage in QM(x) includes, in an embodiment, all latency coverage components, i.e. {T(x), S(x), O(x), D(x)}. In a further implementation, the transaction latency coverage QM(x) includes only one or more of these components.

Further, since each subsequent QM stage is a superset of coverage from previous stages, the four components may also be declared as:

T(x)=T(0)+T(1)+T(2) . . . +T(x−1)+{ . . . tₗ, tₘ . . . }

S(x)=S(0)+S(1)+S(2) . . . +S(x−1)+{ . . . sₗ, sₘ . . . }

O(x)=O(0)+O(1)+O(2) . . . +O(x−1)+{ . . . Oₗ, Oₘ . . . }

D(x)=D(0)+D(1)+D(2) . . . +D(x−1)+{ . . . dₗ, dₘ . . . }

In particular, at step 910, transaction types are determined for all transactions in a current QM stage, such as the first stage, i.e. QM(0). As discussed above, the transaction types may be determined from an identification stored in the packet data. Further, all transaction type latencies are covered as indicated at step 920 which leads to the transaction type latency coverage referred to as T(x). In an embodiment, transaction types are determined from workload data which is processed by the MP test program on the multi-core processor system.

In a modification of this embodiment, the transaction types are ranked according to their frequency of occurrence. It is to be noted that in a further embodiment, the transaction types may be ranked according to another indicator, such as importance for the test program, average transmission time, etc., or are not ranked at all. Further, in the embodiment depicted in FIG. 9, all latencies within a defined range for each transaction type are selected. In particular, for each determined transaction type, the latencies, which fall into a range of transaction latencies defined for the current QM stage, are evaluated and corresponding transactions may be selected. It is again referred to FIG. 4A, which exemplarily depicts ranges of transaction latencies, which will be discussed in more detail below.

The range of transaction latencies is defined as discussed above by μ±γₓ in increments of iₓ %. In detail, μ equals the mean latency for a given transaction type, γₓ equals the range of latency to be covered in stage QM(x), and iₓ equals the increments to be covered within the defined range. Thus, T(0) will contain most frequently occurring transaction types and covers μ±γ₀, while T(x) will contain all transaction types and cover the encompassing range μ±γₓ. For instance, T(0) may include transaction types {t₀, t₁, t₂ . . . }. Thus, the latency coverage for type to in T(0) will include the range μ±γ₀ with i₀ % increments as shown in FIG. 4C. In addition, this Figure further illustrates the growing ranges for subsequent QM stages resulting in the depicted latency coverage for T(0), T(1) through T(x). In an embodiment, the increments are given by i₀, i₁ to iₓ and differ for each QM stage. However, in a further implementation, the increments i_{o . . . x} may be the same for each QM stage.

Referring back to FIG. 9, at step 930, all transaction sequences containing two or more transactions are covered. In particular, sequences of transactions are determined from the collected transaction data, see for example step 810 in FIG. 8. The sequences may be ranked according to frequency from workload data. It is to be noted that in a further embodiment, the sequences may be ranked according to transaction types or any other parameters. Further, the transaction sequence latency coverage component will include all coverage points within μ±γₓ in increments of iₓ %.

Further, the latency coverage for transaction sequences will include all permutations and combinations for points gathered in the above mentioned range for all transactions in a given sequence. For instance, in an embodiment, the transaction sequences are formed from the selected transactions having latencies which fall into the above discussed latency range for the QM stage. The covering of all points within the range and the covering of all permutations and combinations will be repeated for sequences in S(x). Thus, if the sequences are ranked, S(0) contains the most frequently occurring sequences, while S(x) contains all possible valid sequences. For instance, S(0) will have the most frequently occurring sequences {s₀, S₁, S₂ . . . }, where s₀ may be {t₀, t₁, t₂ . . . }.

Referring to FIG. 4D, in an exemplary implementation, the latency coverage for transaction sequences during the initial QM stage QM(0) will have all permutations and combinations illustrated in this Figure. In particular, FIG. 4D shows three covered ranges for three different transaction types. All ranges are defined by γ₀ around the corresponding mean latencies μ₀, μ₁ and μ₂ for the corresponding transaction types.

In addition, transactions or transaction types in a sequence may or may not overlap. Thus, in a step 940, all sets of overlapping transaction types are covered for all permutations and combinations of transaction types. For example, overlapping transaction types are illustrated in FIG. 4E. In particular, FIG. 4E depicts three transactions A, B and C of the types t₃, t₄ and t₁, respectively. The latency coverage component O(x) may be a set of transaction type combinations based on how frequently they overlap in time. In an embodiment, overlap between two transactions will be considered, for example transactions A and B in FIG. 4E, which is herein referred to as first order overlapping. However, in a further embodiment, the overlap of 2 to n transactions will be considered, which is referred to as second/n^{th} order overlapping. In both cases, the absolute overlap may be computed in terms of percentages, for example, in terms of percentages of the maximum overlap between two transactions or, in another embodiment, as a percentage of the total transaction time. However, each overlap between two transactions is given by μ±βₓ in increments of jₓ %, where μ is the mean latency for a given transaction type, βₓ is the range of latency to be covered in stage QM(x) and jₓ determines increments to be covered within the defined range, as illustrated in FIG. 4F. To calculate the transaction overlap latency coverage component, all permutations and combinations for each coverage point within each entity of O(x) are covered, e.g. transactions A and B, A and C, B and C, as well as A, B and C of FIG. 4E.

Further, as an example, O(0) may contain most frequently overlapping transaction sets, while O(x) may contain all possible and valid transaction overlapping scenarios. For instance, transaction overlap sets in O(0) are {o₀, o₁ . . . } where o₀ equals <t₃, t₄>. Thus, transaction types t₃, t₄ overlap most frequently.

As can be seen in FIG. 4E, certain implementations can embody a first order overlapping, i.e. only two transactions exist in o₀, as well as an overlapping up to the n^{th} order. The overlap set O(x) may contain transactions overlapping to the n^{th} order. Moreover, overlapping entities {o₀, o₁, o₂ . . . } are also differentiated by the directions of overlapping. For example, as can be seen in FIG. 4E, the first transaction type t₃ begins before the second overlapping transaction type t₄. These transaction types are in a positive overlapping, i.e. the first packet of the first overlapping transaction type arrives before the first packet of the second transaction type. Similarly, in a negative overlapping, the first transaction type begins after the second overlapping transaction type. Such a negative overlapping can be seen between transaction types t₄ and t₁. Moreover, transactions A and C (types t₃ and t₁) are also in a positive overlapping.

In a further embodiment, the overlap time is calculated for all overlapping transactions. For example, two transactions are contemplated, e.g. transactions A and B in FIG. 4E. The overlap time for these two transactions is computed by taking into account the time stamps of the first and last packets of the transactions. The overlap time for transactions, or in another embodiment for transaction types, may be profiled by a Gaussian distribution. Thus, during a first quiescent mode stage QM(0), the overlap latency coverage for o₀ can be depicted as illustrated in FIG. 4F. In detail, FIG. 4F illustrates the range of overlap latency to be covered in stage QM(0). This range may be defined as μ±βₓ which is μ±β₀ for stage QM(0) in FIG. 4F, where, in this embodiment, μ is the mean overlap time for a given transaction type. Further, the defined range is subdivided by j₀ increments.

Continuing with the method described in FIG. 9, a fourth latency coverage component may be calculated in step 950. In detail, the fourth component referred to as D(x) may be the packet distance latency coverage. As can be seen in FIG. 2, each packet in a transaction is surrounded by two other packets (except the first and last packets). Again, as discussed above, the latency between packets may be variable, so that for each packet in every transaction type there is a variation in distance from the preceding and succeeding packets.

The packet-to-packet latency may also be profiled by Gaussian distributions. However, in a different embodiment, other probability distribution functions can be used. Thus, within each transaction, each packet will have at least a mean latency from the preceding packet, pa, as well as a mean latency from the succeeding packet, μ_{b}.

With respect to FIG. 2, a transaction A₁ may have n packets termed P₀ to Pₙ. Since the first and last packets do not have a preceding or a succeeding packet, respectively, the packet latency coverage component will include coverage for packets P₁ through Pₙ₋₁ in this embodiment of the invention. This can also be seen from the depiction of the parameters shown below. Further, for each packet in each transaction covered in T(x), S(x) and O(x), latency coverage ranges are assigned. The range may be defined as: μₐ±αₓ in increments of kₓ %, and μ_{b}±αₓ in increments of kₓ %. The variable αₓ is the coverage range in the current QM stage, while kₓ may be increments to be covered within the defined range. Thus, the component D(x) covers all permutations and combinations of packet latencies for transactions defined in T(x), S(x) and O(x).

In a further embodiment, μₐ may be the mean distance from a preceding packet, and μ_{b} the mean distance from the succeeding packet. In this embodiment, the component D(x) covers all permutations and combinations of packet distances for transactions defined in T(x), S(x) and O(x).

However, in all possible embodiments of the invention, the following permutations and combinations of packet distance variables are covered:

$$\begin{matrix}\begin{matrix}( {μ}_{a 1} , {μ}_{b 1} ) , \begin{matrix}( {μ}_{a 1} + k , {μ}_{b 1} ) , & ( {μ}_{a 1} + 2 k , {μ}_{b 1} )\end{matrix} … ( {μ}_{a 1} + 2 k , {μ}_{b 1} + 2 k ) … ( {μ}_{a 1} + α , {μ}_{b 1} + α ) \\ ⋮\end{matrix} \\ ( {μ}_{a n - 1} α , {μ}_{b n - 1} - α ) \begin{matrix}… & & …\end{matrix} ( {μ}_{a n - 1} + α , {μ}_{b n - 1} + α )\end{matrix}$$

These permutations and combinations are repeated for all transaction packets in T(x), S(x) and O(x) to create D(x).

Further, by creating such a wide sweep of latency coverage across T(x), S(x), O(x) and D(x), many redundant coverage terms are generated given the throughput in actual systems, however, it is better to stay on the conservative side. In a further embodiment of the present invention, redundant coverage terms may be deleted from the latency coverage components.

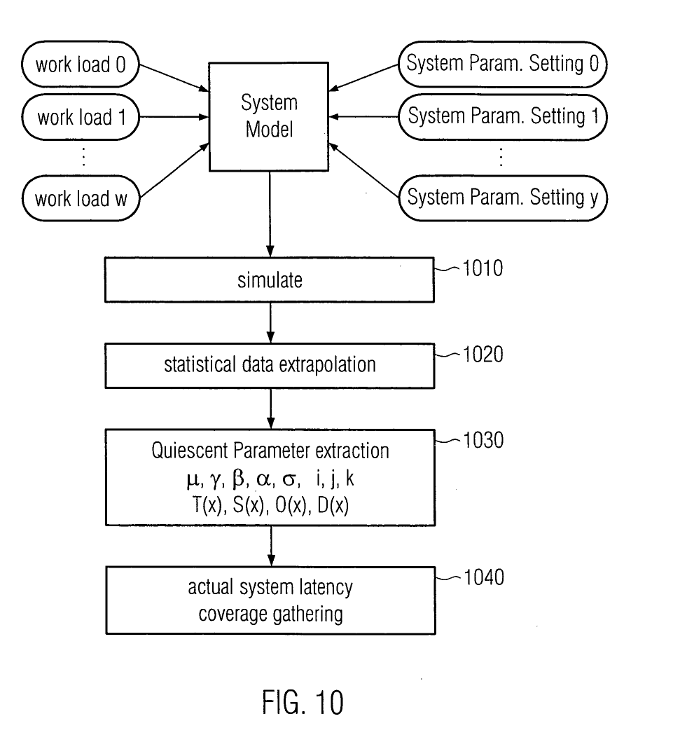

Referring now to FIG. 10, a further embodiment is depicted, where a plurality of workload data, workload 0 to workload w, is provided to a system model. Further, the system model is also provided with system parameter settings 0 through y. With these starting conditions, the system model will be simulated at step 1010. Further, statistical data is extrapolated as shown at step 1020. This statistical data extrapolation may include, in an embodiment of the present invention, the collecting of transaction data and the calculation of latency data from transaction data, including the evaluation of results of statistical functions, such as the Gaussian distribution function. Further, at step 1030, the quiescent parameters are extracted, which are outlined above in conjunction with the four latency coverage components. Finally, at step 1040, the latency coverage is gathered for the actual system.

It is noted that various embodiments may accomplish as a consequence of achieving high transaction latency coverage, the creation of stimulus generation templates for 24×7 validation regression. As outlined above, after the random MP program generator templates (RMPPT) are created from coverage gathering and targeting exercise, those templates are ideal for running 24×7 on multiple platforms. The systems are to be set up with different combinations of initial parameters such as cache sizes, queue sizes, link sizes etc.

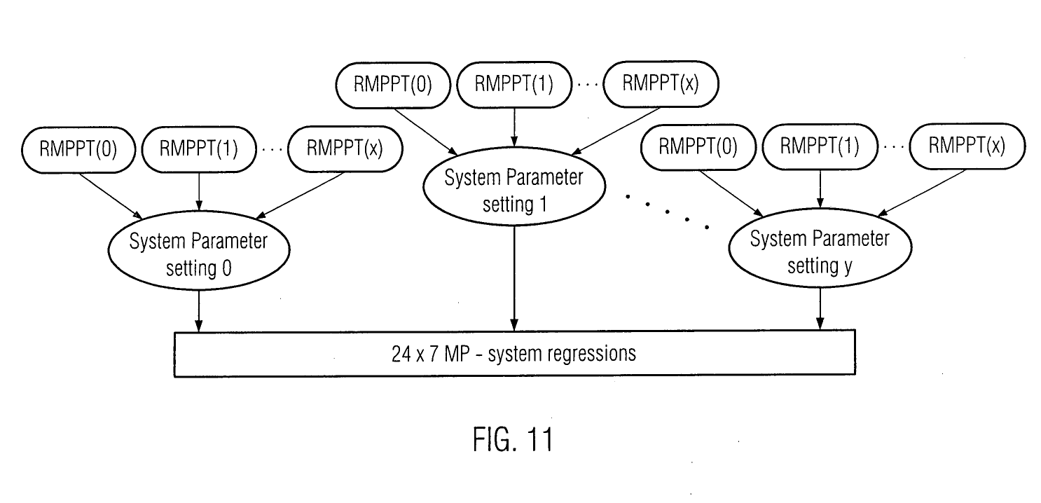

As can be seen in FIG. 11, the various RMPPTs created for the different QM stages, i.e. RMPPT(0) to RMPPT(x), are provided together with a certain system parameter setting for a 24×7 MP system regression. The various templates together with different parameter settings are provided for regression. Thus, up to y system parameter settings are provided for regressions, each together with all created RMPPTs. The system parameter settings 0 through y may include variations in cache sizes, queue sizes, buffer sizes, link sizes, DRAM latencies, system configurations, link width, link frequency, etc. Thus, the RMPPTs derived from the latency coverage generation as discussed above may be used for 24×7 silicon regressions.

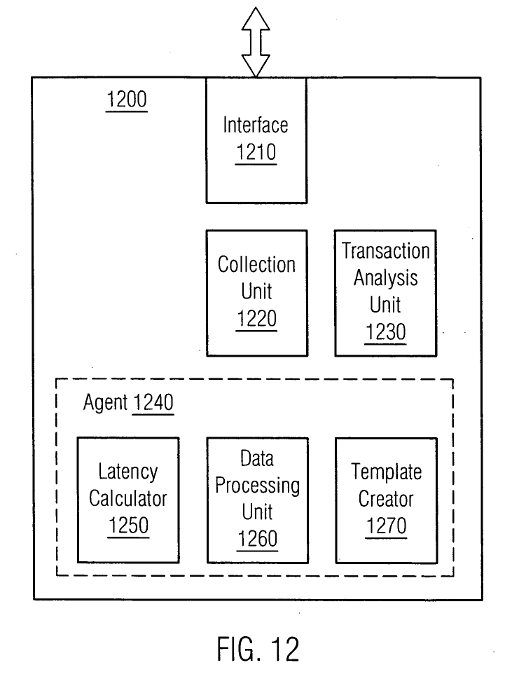

With reference to FIG. 12, an exemplary system for gathering and processing transaction latency data is illustrated, which may be employed to implement the present invention. In detail, the system 1200 includes, in an embodiment, an interface 1210 to couple to the multi-core multi-node microprocessor system of FIG. 1. The interface 1210 may be implemented in hardware or software, such as an Application Programming Interface (API), or a combination of hardware and software. Further, the system 1200 may be external to the multi-core multi-node microprocessor system of FIG. 1 and obtains transaction related data via the interface 1210 for further processing. In a further embodiment, the system 1200 may be internal to the multi-core multi-node microprocessor system of FIG. 1. In this embodiment, the system 1200 may not require the interface 1210, but may have direct access to the collected transaction data, e.g. may be directly coupled to the TCB 115 of FIG. 1. Further, the system 1200 may even not require a collection unit 1220, which is explained further below. It may be sufficient that the multi-core multi-node microprocessor system of FIG. 1 embodies or implements a transaction analysis unit 1230 and an agent 1240 comprising the modules 1250-1270 depicted in FIG. 12 for observing transactions during a test program and for gathering transaction latency coverage data.

However, in one embodiment, the system 1200 may be an external system and is coupled to the TCB 115 of FIG. 1 via the interface 1210. The collection unit 1220 may thus access transaction data buffered in the TCB 115 and collects the transaction data for further processing. This may be accomplished by transaction analysis unit 1230, which identifies transactions and transaction types of the transaction data. In a further implementation of system 1200, the transaction analysis unit 1230 also identifies time information, such as time stamp data of each transaction packet.

Further, the agent 1240 may include three components or modules implementing parts of the method illustrated in FIGS. 7 to 9. In particular, the agent 1240 may comprise a latency calculator, a data processing unit and a template creator. The data processing unit may process the data output from the latency calculator to gather transaction latency coverage data, which may be available for further processing. In addition, the template creator may access the transaction latency coverage data to create random test generator templates therefrom.

As described from the foregoing, stimulus generation templates for 24×7 validation regression may be created based on transaction latencies. This method may be performed on actual systems instead of simulations. As a consequence of covering a wide range of transaction sequences and latencies, many random test generator templates are created. These templates are to be used as the basis for 24×7 regressions on MP systems.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

What is claimed is:

1. A method in a multi-core processor system, the method comprising:
collecting transaction data relating to transactions in the multi-core processor system;
calculating latency data from the collected transaction data;
processing the calculated latency data to gather transaction latency coverage data being data indicating at least the latencies of the transactions detected during collection of the transaction data having a pre-determined latency; and
creating random test generator templates from the gathered transaction latency coverage data.

2. The method of claim 1, further comprising:
running a multiprocessor test program on the multi-core processor system for various quiescent mode, QM, stages having a hierarchical order, wherein a first QM stage represents a mode of typical workload conditions, and wherein creating random test generator templates comprises creating a random test generator template for each QM stage.

3. The method of claim 2, wherein processing the calculated latency data comprises:
determining transaction types of the transactions for which transaction data has been collected;
for each transaction type, selecting all transactions having a latency falling into a range of transaction latencies defined for a current QM stage; and
forming a type component for the current QM stage, the component including all transaction types of the selected transactions and corresponding latencies.

4. The method of claim 2, wherein processing the calculated latency data further comprises:
determining transaction types of the transactions for which transaction data has been collected;
for each transaction type, selecting all transactions having a latency falling into a range of transaction latencies defined for a current QM stage;
determining transaction sequences of two or more transactions, the transaction sequences being determined from permutations and combinations of the selected transactions; and
forming a sequence component for the current QM stage, the component including all determined transaction sequences and corresponding latencies.

5. The method of claim 2, wherein processing the calculated latency data further comprises:
determining transaction types of the transactions for which transaction data has been collected;
for each transaction type, selecting all transactions having a latency falling into a range of transaction latencies defined for a current QM stage; and
determining sets of overlapping transactions, the sets being determined from permutations and combinations of the selected transactions; and
forming an overlap component for the current QM stage, the component including all determined sets of overlapping transactions and corresponding latencies.

6. The method of claim 2, further comprising:
determining transaction types of the transactions for which transaction data has been collected;
determining sets of overlapping transaction types, the sets being determined from permutations and combinations of the determined transaction types;
calculating an overlap time for each set of overlapping transaction types;
selecting all sets of overlapping transaction types having an overlap time falling into a range defined for a current QM stage; and
forming an overlap component for the current QM stage, the component including all selected sets of overlapping transaction types.

7. The method of claim 2, wherein processing the calculated latency data further comprises:
selecting all transactions for which transaction data has been collected;
calculating, for each packet in the selected transactions except the first and the last packet of a transaction, a packet distance in time for each of its two respective preceding and succeeding packets;
selecting packets having a packet distance falling into a range defined for a current QM stage;
determining permutations and combinations of preceding packet distance and succeeding packet distance for the selected packets; and
forming a packet distance component including all determined permutations and combinations of packet distances.

8. The method of claim 2, wherein processing the calculated latency data further comprises:
selecting all transactions for which transaction data has been collected;
evaluating, for each packet in the selected transactions except the first and the last packet of a transaction, a packet latency for each of its two respective preceding and succeeding packets;
selecting packets having a preceding packet latency and a succeeding packet latency both falling into a range defined for a current QM stage;
determining permutations and combinations of preceding packet latency and succeeding packet latency for the selected packets; and
forming a packet distance component including all determined permutations and combinations of packet latencies.

9. The method of claim 2, wherein collecting transaction data comprises:
determining whether a trace capture buffer of the multi-core processor system is full;
if the trace capture buffer is full, collecting transaction data from the trace capture buffer, and shifting the trace capture buffer window.

10. The method of claim 2, further comprising:
determining whether processing the calculated latency data to gather transaction latency coverage data is complete;
if the processing is not complete, iteratively fine tuning the random test generator template until coverage data is complete, and
if the processing is complete, storing the random test generator template for a current QM stage.

11. The method of claim 2, further comprising:
selecting a first QM stage for running the multiprocessor test program;
determining whether the multiprocessor test program has been run for each QM stage;
if the multiprocessor test program has not been run for each QM stage, selecting a subsequent QM stage and running the multiprocessor test program at the subsequent QM stage including processing the calculated latency data and creating the random test generator template for the subsequent stage.

12. The method of claim 2, wherein transaction latencies for a transaction type are profiled by a probability distribution, wherein a range of transaction latencies is a range symmetric to the mean latency of the probability distribution, and wherein the size of the ranges increases for each subsequent QM stage.

13. The method of claim 1, wherein the random test generator templates are random multiprocessor program generator templates.

14. A multi-core multi-node processor system comprising:
a plurality of multiprocessor nodes each having a plurality of microprocessor cores, the plurality of microprocessor nodes and cores being connected to form a transactional communication network;
one or more buffer units configured to collect transaction data relating to transactions sent from one core to another core in the multi-core multi-node processor system; and
an agent configured to:
calculate latency data from the collected transaction data;
process the calculated latency data to gather transaction latency coverage data being data indicating at least the latencies of the transactions detected during collecting of the transaction data having a pre-determined latency; and
create random test generator templates from the gathered transaction latency coverage data.

15. The multi-core multi-node processor system of claim 14, wherein the buffer unit is further adapted to time stamp each data packet of incoming transactions, wherein the time stamp indicates the point of time at which the respective packet has been captured and stored in the buffer unit.

16. The multi-core multi-node processor system of claim 15, further comprising:
a transaction analysis unit configured to identify transactions and corresponding transaction types;
wherein the agent is further configured to determine transaction latency coverage components by evaluating probabilistic functions for the latencies of the identified transaction types, by evaluating transaction sequences of the identified transaction types, and by evaluating overlap times for the identified transactions using the time stamps of the transaction packets.

17. The multi-core multi-node processor system of claim 16, wherein the agent is further configured to calculate, for each packet of a transaction except the first and the last packet of a transaction, a packet latency for each of its two respective preceding and succeeding packets by evaluating the time stamps of the packets, and wherein the agent is further configured to determine the transaction latency coverage components by evaluating probabilistic functions for the packet latencies.

18. The multi-core multi-node processor system of claim 14, wherein the buffer unit is a trace capture buffer and the system is running a multiprocessor test program, and wherein the system further comprises:
a buffer handler configured to determine whether the trace capture buffer is full, and if so, collect transaction data from the trace capture buffer, and shift the trace capture buffer window.

19. The multi-core multi-node processor system of claim 18, wherein the multi-core multi-node processor system is running the multiprocessor test program for a combination of a plurality of different workload data and a plurality of system parameter settings, and wherein the plurality of system parameter settings comprises variations of at least one of cache sizes, queue sizes, buffer sizes, link sizes, DRAM latencies, system configurations, link width and link frequency.

20. A test program template generator comprising:
a collection unit configured to collect transaction data relating to transactions in a multi-core processor system;
a latency calculator configured to calculate latency data from the collected transaction data;
a data processing unit configured to process the calculated latency data to gather transaction latency coverage data being data indicating at least the latencies of the transactions detected during collection of the transaction data having a pre-determined latency; and
a template creator configured to create random test generator templates from the gathered transaction latency coverage data.
